(19) United States
(12) Patent Application Publication
(10) Pub. No.: US 2025/0387651 A1
(43) Pub. Date: Dec. 25, 2025

(54) PERSONAL PROTECTIVE EQUIPMENT MASK WITH EXCHANGABLE FILTER

(71) Applicant: FXI INC. LIMITED, London (GB)

(72) Inventors: Dennis TURNER, London (GB); Sanjay PURKAYASTHA, London (GB); James KINROSS, London (GB)

(21) Appl. No.: 19/244,451

(22) Filed: Jun. 20, 2025

Related U.S. Application Data
(60) Provisional application No. 63/662,269, filed on Jun. 20, 2024.

(51) Int. Cl. A62B 23/02; A62B 18/08; A62B 18/10

(52) U.S. Cl. CPC A62B 23/025; A62B 18/084; A62B 18/10

(57) ABSTRACT

The present disclosure is related to a facial covering assembly. The facial covering assembly includes a form structure comprising a form structure opening, an inner frame coupled to the form structure, an outer frame coupled to the inner frame, a filter material coupled to the inner frame and disposed between the inner frame and the outer frame, and a fastener coupled to the inner frame. The inner frame includes an inner frame body and an inner frame opening disposed in the inner frame body. The outer frame includes an outer frame body and an outer frame opening disposed in the outer frame body.

### CROSS-REFERENCE TO RELATED APPLICATIONS

This application claims priority to U.S. Provisional Patent Application No. 63/662,269, filed Jun. 20, 2024, which is herein incorporated by reference in its entirety.

### BACKGROUND

### Field

The disclosure generally relates to an apparatus (e.g., facial wear articles) for covering the nose and mouth of a user. In particular, the disclosure is related to a facial covering assembly having a form structure that is shaped to allow fitment to the majority of facial types.

### Description of Related Art

In healthcare settings, PPE may be worn by surgeons, doctors, nurses, anesthesiologists, technicians, assistants, and other persons permitted into an operating room or other healthcare facility. Additionally, they may be worn during general examinations, especially of contagious or potentially contagious persons or animals (e.g., avian flu, Ebola virus) and/or immunodeficient persons or animals. Further, persons tasked with environmental clean-up and inspection may wear PPE to protect against environmental exposure to infectious and/or toxic substances. Further still, in recent years, worldwide outbreaks of certain serious and highly contagious diseases have prompted individuals to wear PPE masks in daily life.

Over the last 100 years, three major influenza pandemics of have occurred, of which the “Spanish flu” of 1918 was the largest with regard to infection and mortality rate. The recent global concern is the Coronavirus disease 2019 (COVID-19), which is an infectious disease caused by severe acute respiratory syndrome coronavirus 2 (SARS-COV-2). The virus is primarily spread between people during close contact, most often via small droplets produced by coughing, sneezing, and talking. The droplets usually fall to the ground or onto surfaces. It is most contagious during the first three days after the onset of symptoms, although spread is possible before symptoms appear, and from people who do not show symptoms.

Recommended measures to prevent infection include frequent hand washing, maintaining physical distance from others and quarantine (especially for those with symptoms), covering coughs, and keeping unwashed hands away from the face.

The inhalation of air contaminated by harmful virus and/or other micro-organisms is a common route for infection of human beings, particularly health workers and others who work with infected humans or animals. Air exhaled by infected patients is a source of contamination. At the present time the risk of infection by COVID-19 virus is of particular concern. Masks or respirators incorporating a suitable filter material would be ideal for use as a barrier to prevent species-to-species transmission of the virus.

Fit testing is a means of checking that a respirator face piece matches a person's facial features and seals adequately to their face. The performance of tight fitting respirators relies on achieving a good seal between the face piece of the respirator and the user's face. If the seal is inadequate, contaminated air may take the path of least resistance and may travel through leaks in the face seal. Consequently, a poor seal to the face may reduce the level of protection provided to the user.

In the current state of the art, a mask covers the face with a single layer of filtration material with a limited surface area and without a good fit. The filtration material may vary in design and material depending on the level of filtration provided by the mask. The mask is uncomfortable to wear due to the heat buildup between the mask material and the user's skin. The heat buildup occurs because the mask's filtration limits the free flow of exhaled air from the nose or mouth. This creates a backflow of warm and moist air that warms the nostrils and face behind the mask and is unpleasant. This warm and moist backflow of air pervades throughout the face behind the mask and leaks out around the edges, which can fog glasses or allow viruses both into and out of the mask. This sensation of warm moist respiration around a user's nose is a complaint among mask users, especially those that must wear them for extended periods of time, such as medical professionals.

In particular, female healthcare workers and those from Black and Minority Ethnic (BAME) backgrounds have struggled to find personal protective equipment (PPE) that provides them with adequate protection, a new study has found. This is because most masks are not designed for BAME and women, due to limited research into how differences in facial dimensions across gender and ethnicity affect PPE performance.

A personal protection equipment (PPE) respirator device may include a face piece having a molded body designed to fit over a nose and a mouth of a user, the molded body configured to define a sealable space formed around the nose and the mouth of the user for delivering air to the user. Other approaches are to have a surgical mask having partitions that isolate the respiration from the nose and mouth of a user into two separate compartments or volumes.

FIG. 1 is a three-ply surgical face mask. A typical PPE mask may include an air-permeable filter and a mechanism by which the filter may be affixed to the face. In certain configurations, one or more bands, strings, or straps are provided which are intended to tie or fasten at the back of the users head.

A disadvantage of some facial coverings is that the frame holds the three-ply surgical face mask. Thus, the filter or mask is larger than the frame, resulting in excess material being exposed and potentially contaminated. Furthermore, the frame can only be used with a typical surgical FFP2, FFP3, or N95 filter element. Furthermore, the seal with the face on some facial coverings is defined by the shape of the inner frame, and thus limits fitting to a narrow range of facial types. The use of a three-ply surgical face mask also means that a seal is difficult to make given the folded (creased) nature of surgical masks.

FIG. 2 is a prior art FFP3 style respirator. Some masks are shaped to create a cone of material away from the users face. However, this shape exacerbates the poor nature of the fit to the users face.

Preparedness to next virus pandemic requires new materials and concepts for mask. The gold standard N-95 mask is more effective than surgical masks, but does not allow for comfortable and adequate fit for a large percentage of the population. More generally, the PPE gear found in the current state of the art may be uncomfortable to the user, which may cause distraction and/or irritation during critical work. Further, movement of the user may cause disruption to the PPE configuration and/or sealing of the PPE. Thus, increasing comfort to the user and increasing adherence of the PPE in its proper position is desirable.

Thus, there is a need for a light weight face mask that allows fitment to the widest range of facial sizes and shapes, can be maintained by washing with just the active filter being replaced, and that allows for replacement of the active filter to different levels of protection and breathability depending on the application.

### SUMMARY

Aspects of disclosure provide an apparatus (e.g., facial wear articles) for covering the nose and mouth of a user. In particular, the disclosure is related to a facial covering assembly having a form structure that is shaped to allow fitment to the majority of facial types.

In one embodiment, a facial covering assembly is disclosed. The facial covering assembly includes a form structure comprising a form structure opening, an inner frame coupled to the form structure, an outer frame coupled to the inner frame, a filter material coupled to the inner frame and disposed between the inner frame and the outer frame, and a fastener coupled to the inner frame. The inner frame includes an inner frame body and an inner frame opening disposed in the inner frame body. The outer frame includes an outer frame body and an outer frame opening disposed in the outer frame body.

In another embodiment, a facial covering assembly is disclosed. The facial covering assembly includes a form structure comprising a form structure opening, an inner frame coupled to the form structure, an outer frame coupled to the inner frame, a filter material, and a fastener coupled to the inner frame. The inner frame includes an inner frame body, an opening disposed in the inner frame body, and an inner frame structure is disposed within the opening. The outer frame includes an outer frame body and an opening disposed in the outer frame body. The filter material is coupled to the inner frame and disposed between the inner frame and the outer frame. The inner frame structure supports the filter material.

In yet another embodiment, the facial covering assembly is disclosed. The facial covering assembly includes a form structure comprising a form structure opening, an inner frame coupled to the form structure, an outer frame coupled to the inner frame, a filter material, and a fastener. The inner frame includes an inner frame body. The inner frame body includes a first end portion, a second end portion, an upper connector, a lower connector, an inner frame opening, an inner frame structure disposed in the opening, a first protrusion, and a second protrusion. The first end portion and the second end portion are connected via the upper connector and the lower connector. The inner frame opening is disposed in the inner frame body and defined by the first end portion, the second end portion, the upper connector, and the lower connector. The first protrusion is disposed on an outer surface of the inner frame body on the first end portion. The second protrusion is disposed on an outer surface of the inner frame body on the second end portion. The outer frame comprises an outer frame body. The outer frame body includes a first end portion, a second end portion, an upper connector, a lower connector, an outer frame opening disposed in the outer frame body, a first protrusion opening, and a protrusion opening. The first end portion and the second end portion are connected via the upper connector and the lower connector. The outer frame opening is defined by the first end portion, the second end portion, the upper connector, and the lower connector. The first protrusion is received within the first protrusion opening. The second protrusion is received within the second protrusion opening. The filter material is coupled to the inner frame and disposed between the inner frame and the outer frame. The inner frame structure supports the filter material. The fastener is coupled to the inner frame.

### BRIEF DESCRIPTION OF THE DRAWINGS

The disclosure may be understood by reference to the following description taken in conjunction with the accompanying drawings, in which, like reference numerals identify like elements. These drawings illustrate certain embodiments of the present disclosure and are not to be used to improperly limit the scope of the disclosure that may have other equally effective or legally equivalent embodiments.

FIG. 1 is a prior art three-ply surgical face mask, according to embodiments.

FIG. 2 is a prior art FFP3 style respirator, according to embodiments.

FIG. 3A is an exploded, perspective view of a facial covering assembly, according to embodiments.

FIG. 3B is a perspective front view of the facial covering assembly, according to embodiments.

FIG. 3C is a rear perspective view of the facial covering assembly, according to embodiments.

FIG. 3D is a rear view of the facial covering assembly, according to embodiments.

FIG. 3E is a bottom view of the facial covering assembly, according to embodiments.

FIG. 4A is a perspective view of the fastener coupled to the inner frame, according to embodiments.

FIG. 4B is a perspective cross-sectional view of a fastener of the inner frame, according to embodiments.

FIG. 5 is a fastener clasp of the fastener, according to embodiments.

FIG. 6A is a front perspective of the form structure of the facial covering assembly, according to embodiments.

FIG. 6B illustrates a rear perspective of the form structure, according to embodiments.

FIG. 7A is a front perspective of the inner frame coupled to the form structure, according to embodiments.

FIG. 7B is a rear perspective of the inner frame coupled to the form structure, according to embodiments.

FIG. 7C is cross-sectional view of the inner frame coupled to the form structure, according to embodiments.

FIG. 8A is the filter material, according to embodiments.

FIG. 8B is the filter material with an exhaust valve, according to embodiments.

FIG. 9A is a rear perspective view of the filter material, the inner frame, and the form structure, according to embodiments.

FIG. 9B is a cross-sectional view of the filter material, the inner frame, and the form structure, according to embodiments.

FIG. 10 is a rear view of the outer frame, according to embodiments, according to embodiments.

FIG. 11A is a front perspective view of the facial covering assembly, according to embodiments.

FIG. 11B is a cross-sectional view of the facial covering assembly, according to embodiments.

FIG. 12A is a first front perspective of the facial covering assembly secured to a user, according to embodiments.

FIG. 12B is a second front perspective of the facial covering assembly secured to a user, according to embodiments.

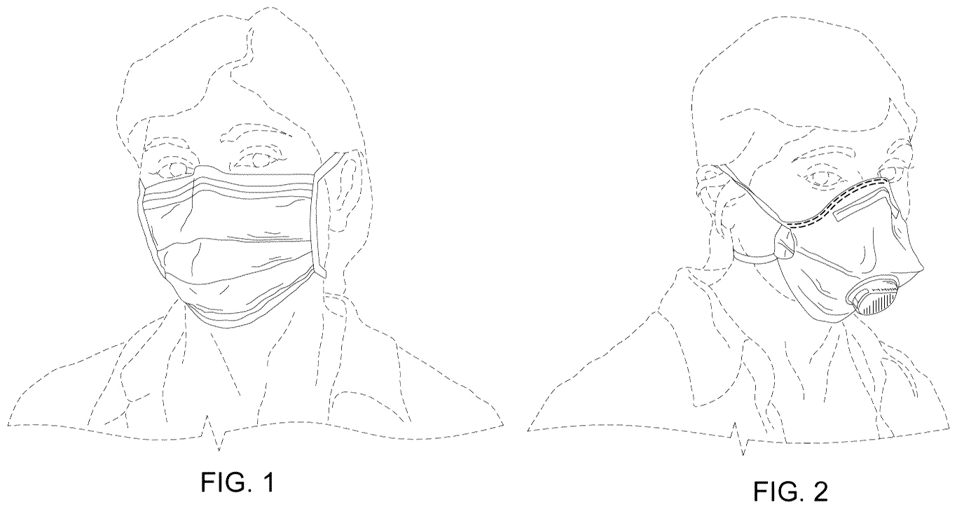

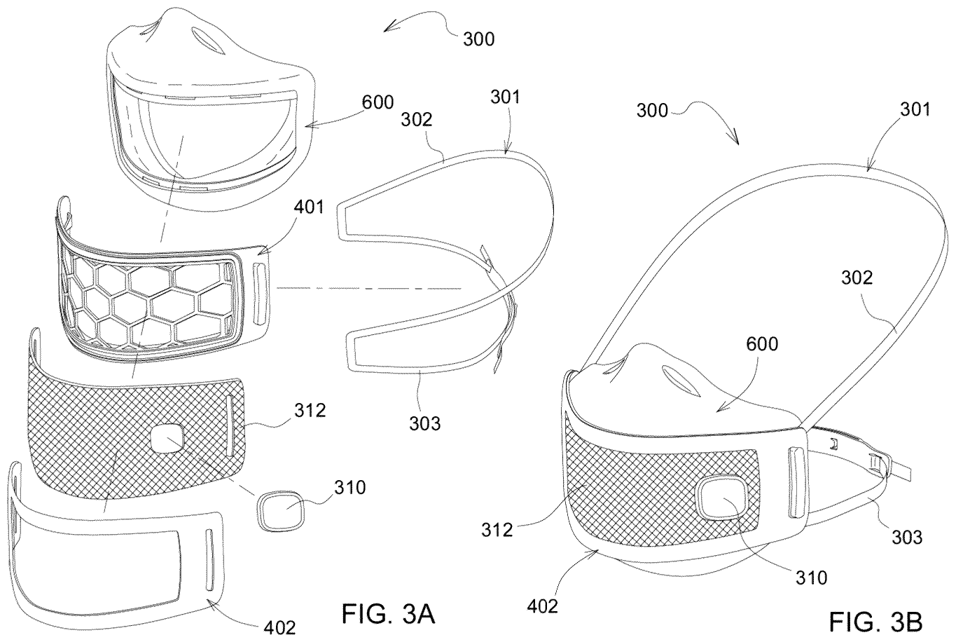

### DETAILED DESCRIPTION

The present disclosure generally relates to an apparatus (e.g., facial wear articles) for covering the nose and mouth of a user. In particular, the disclosure is related to a facial covering assembly having a form structure that is shaped to allow fitment to the majority of facial types.

A facial covering assembly may include an inner frame, which in turn may include at least one aperture to allow air flow through the inner frame, and an outer frame configured to couple to the inner frame. The outer frame may include at least one aperture to allow air flow through the outer frame. The facial covering assembly may further include a cushioning element configured to couple to the inner frame, the cushioning element configured to establish a seal around at least a portion of a user's face. In this approach, the filter element, and bands, strings, or loops to tie or fasten at the back of the users head are components of a typical surgical mask.

In accordance with one or more implementations of the present disclosure, a facial covering assembly includes a form structure, an inner frame, and outer frame, and a filter material. The form structure is shaped to allow fitment to the majority of facial types and establishes a seal around at least a portion of a user's face. The form structure ensures attachment during normal facial expression and movement of the user.

The inner frame is attached to the form structure and a filter of desired performance is disposed between the inner frame and the outer frame. The connection between the inner frame and the outer frame provides an efficient seal for the filter material with the form structure. A convex structure of the inner frame and the outer frame holds the filter away from the user's mouth and nose, providing more comfort for long term usage and to decrease the occurrence of nasal air flow obstruction and skin irritation.

The facial covering assembly provides a substantially airtight seal so as to preclude moisture vapor transfer and “fogging” of eyewear or instruments. One or more bands, strings, elasticated loops or straps are provided which are intended to tie or fasten at the back of the users head.

The facial covering assembly may be used in medical procedures (e.g., endoscopic and/or microscopic surgery, treatment of infectious patients, etc.), environments where there is potential exposure to infectious or toxic substances (e.g., natural disaster sites, sewer spills or leakages, locations known to harbor infectious or toxic agents, etc.), and/or worksites requiring clean rooms (e.g., semiconductor fabrication plants, electron gun fabrication plants, etc.).

The facial covering assembly provides for improved facemask filtration as compared against the established surgical grade masks in circulation (e.g., current surgical and N95 masks). These established surgical grade masks, in some instances, (a) are not effective at providing a seal to the face of the majority of users; (b) are not re-usable; and (c) do not have the ability to change out filters to match the application or exposure to the user.

The facial covering assembly may further include one or more eyewear engagement features configured to couple to eyewear devices. The facial covering assembly may further include one or more user engagement features configured to secure to a user's ear.

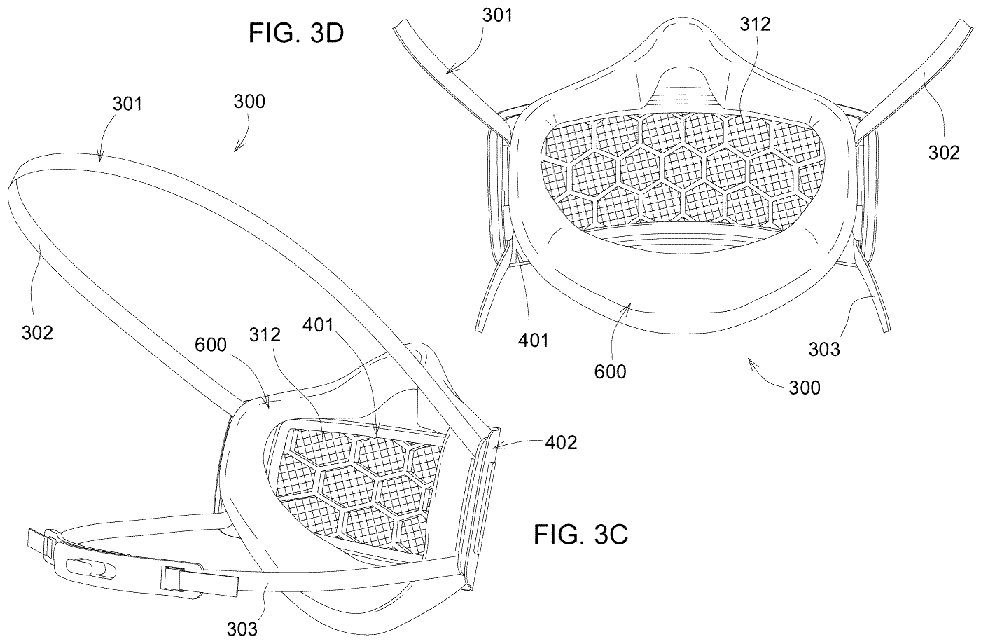

FIG. 3A is an exploded, perspective view of a facial covering assembly 300. FIG. 3B is a perspective front view of the facial covering assembly 300. FIG. 3C is a rear perspective view of the facial covering assembly 300. FIG. 3D is a rear view of the facial covering assembly 300. FIG. 3E is a bottom view of the facial covering assembly 300. The facial covering assembly 300 includes a fastener 301, a filter material 312, an inner frame 401, an outer frame 402, and a form structure 600.

The inner frame 401 is coupled to the filter material 312. The inner frame 401 and the filter material 312 have complementary tabs and slots that ensure the location of the filter material 312 over the inner frame 401.

The inner frame 401 is coupled to the outer frame 402. The inner frame 401 and the outer frame 402 have complementary tabs, slots, ridges, or catches that create a seal between the inner frame 401, the filter material 312, and the outer frame 402. The outer frame 402 is coupled to the inner frame 401 such that the filter material 312 is disposed between the inner frame 401 and the outer frame 402. The inner frame 401 is curved to hold the filter material 312 away from the mouth and nose of the user. The outer frame 402 is shaped to compliment the curve of the inner frame 401.

The inner frame 401 is coupled to the form structure 600. The form structure 600 and the inner frame 401 have complementary tabs, slots, ridges, or catches that create a seal between the form structure 600 and the inner frame 401 while retaining the flexibility of the facial covering assembly 300 to the users face.

The inner frame 401 is coupled to the fastener 301. The facial covering assembly 300 is secured to a user's head using the fastener 301. In some embodiments, the fastener 301 may include one or more fasteners. In other embodiments, the fastener 301 includes an upper fastener portion 302 and a lower fastener portion 303. The fastener 301 may include bands, strings, elasticated loops or straps that tie or fasten at the back of the user's head. The inner frame 401 has complementary tabs, slots, or catches that allow attachment of the fastener 301 (e.g., one or more bands, strings, elasticated loops or straps) to the inner frame 401.

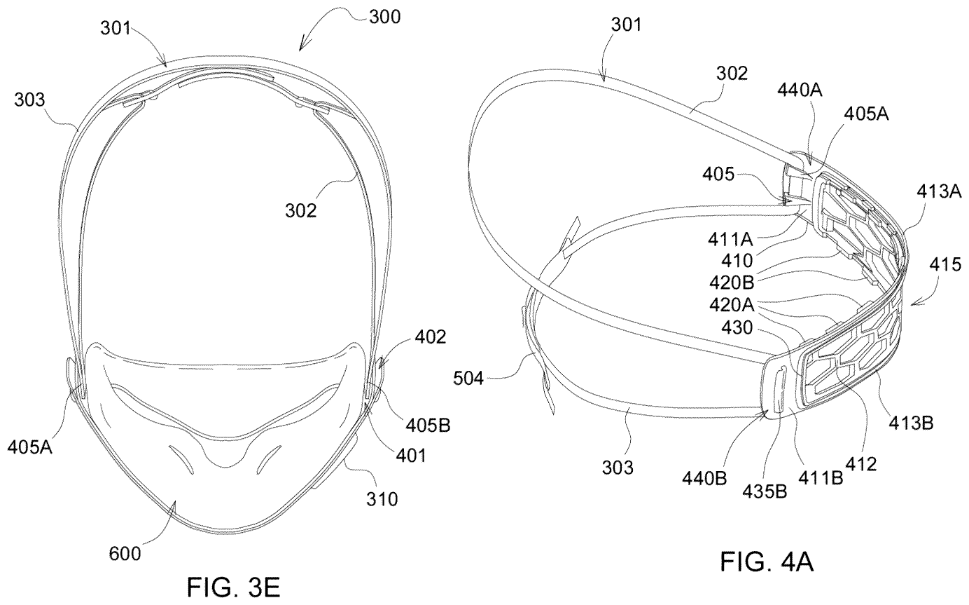

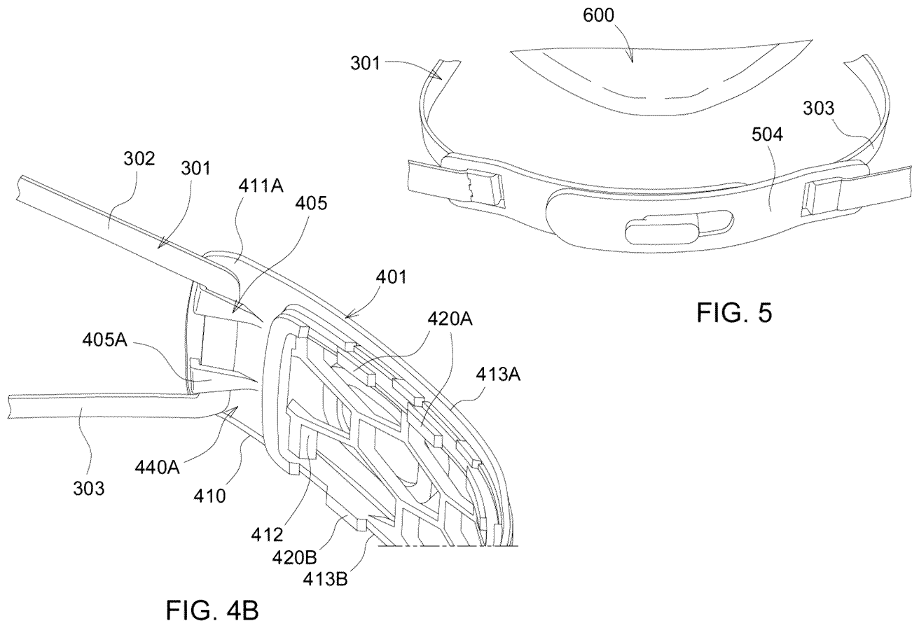

FIG. 4A is a perspective view of the fastener 301 coupled to the inner frame 401. FIG. 4B is a perspective cross-section view of a fastener 301 of the inner frame 401. FIG. 5 is a fastener clasp 504 of the fastener 301. The fastener clasp 504 is configured to adjust the fastening of the facial covering assembly to the user's head.

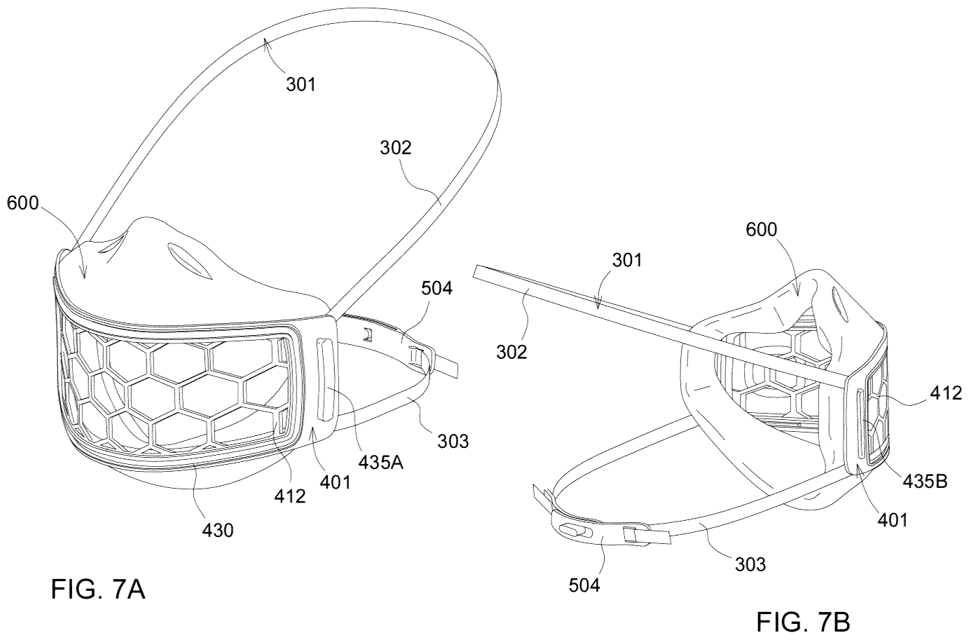

The inner frame 401 is substantially convex. The inner frame 401 includes an inner frame body 410 and an inner frame opening 415 formed in the inner frame body 410. The inner frame body 410 has an inner surface 440A and an outer surface 440B. The inner frame body 410 further includes a first end portion 411A, a second end portion 411B, an upper connector 413A, and a lower connector 413B. The inner frame opening 415 is defined by the first end portion 411A, the second end portion 411B, the upper connector 413A, and the lower connector 413B. The first end portion 411A and the second end portion 411B are connected via the upper connector 413A and the lower connector 413B. The upper connector 413A of the inner frame 401 includes one or more upper tabs 420A and the lower connector 413B of the inner frame 401 includes one or more lower tabs 420B. A filter ridge 430 is formed on the outer surface 440B of the inner frame body 410 and surrounds the inner frame opening 415. The filter ridge 430 includes a filter clamp 431 (see FIG. 7C).

The inner frame 401 includes at least one fastener tab 405. Each fastener tab 405 is coupled to the inner frame body 410. In some embodiments, a first fastener tab 405A is disposed on the inner face 430A on the first end portion 411A of the inner frame body 410 and a second fastener tab 405B is disposed on the inner face 430A on the second end portion 411B of the inner frame body 410. The fastener 301 may be coupled to the inner frame 401 via the fastener tab 405.

The inner frame 401 further includes an inner frame structure 412. The inner frame structure 412 is disposed within the inner frame opening 415. The inner frame structure 412 may be a skeletal structure configured to support the filter material 312 and allow ready air flow through the inner frame opening 415. The shape of the inner frame structure 412 may be a hexagonal matrix or any suitable structure that provides physical support to the filter material 312.

A first protrusion 435A is disposed on the outer surface 440B on the first end portion 411A of the inner frame body 410 and a second protrusion 435B is disposed on the outer surface 440B on the second end portion 411B of the inner frame body 410. The inner frame 401 is made of a polymer, for example acrylonitrile butadiene styrene (ABS), polymethyl methacrylate (PMMA), polyethylene terephthalate glycol (PETG), polylactic acid (PLA) or other suitable material.

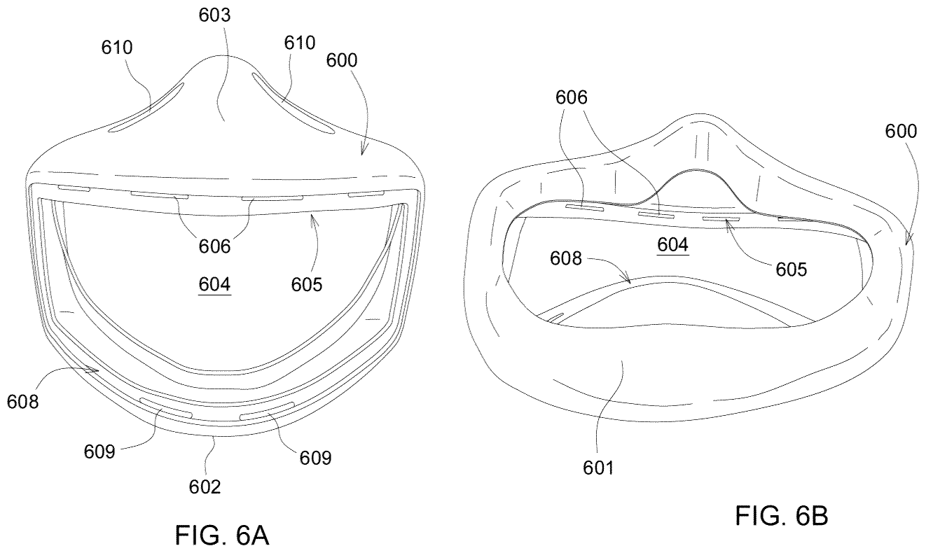

FIG. 6A is a front perspective of the form structure 600 of the facial covering assembly 300. FIG. 6B illustrates a rear perspective of the form structure 600. The form structure 600 may be a form structure 600. The form structure 600 is made of a moldable plastic, e.g., silicone, Thermoplastic, Neoprene, or other suitable material. The material of the form structure 600 is such that it can be readily cleaned with surfactant or detergent and reused.

The form structure 600 includes an interior surface 601, a lower exterior surface 602, an upper exterior surface 603, and a form structure opening 604. The interior surface 601 is configured to fit against the face of the user. The material of the form structure 600 is rolled over to form the interior surface 601 and to ensure consistent sealing with the face of the user. The shape of the form structure 600 is such that it makes a continuous seal with the face of the user irrespective of the size of the user's face. Furthermore, the form structure 600 allows for the seal between the form structure 600 and the skin of the user in order to remain sealed even when facial expressions are altered or when the user is talking.

A first ridge 605 extends from the upper exterior surface 603 and into the form structure opening 604. The form structure 600 has first slots 606 disposed in a first ridge 605. A second ridge 608 extends from the lower exterior surface 602 and into the form structure opening 604. The form structure 600 has second slots 609 disposed in the second ridge 608. The form structure 600 may further include indentations 610 (e.g., grooves) located in an upper exterior surface 603 to allow location of eyeglasses or safety glasses.

FIG. 7A is a front perspective of the inner frame 401 coupled to the form structure 600. FIG. 7B is a rear perspective of the inner frame 401 coupled to the form structure 600. FIG. 7C is cross-sectional view of the inner frame 401 coupled to the form structure 600. The inner frame 401 is coupled to the form structure 600 via the first slots 606, one or more upper tabs 420A, second slots 609, and one or more lower tabs 420B. The first slots 606 of the first ridge 605 are configured to receive the one or more upper tabs 420A. The second slots 609 of the second ridge 608 are configured to receive the one or more lower tabs 420B. The connection between the first slots 606, one or more upper tabs 420A, second slots 609, and one or more lower tabs 420B enable a tight location of the form structure 600 to the inner frame 401.

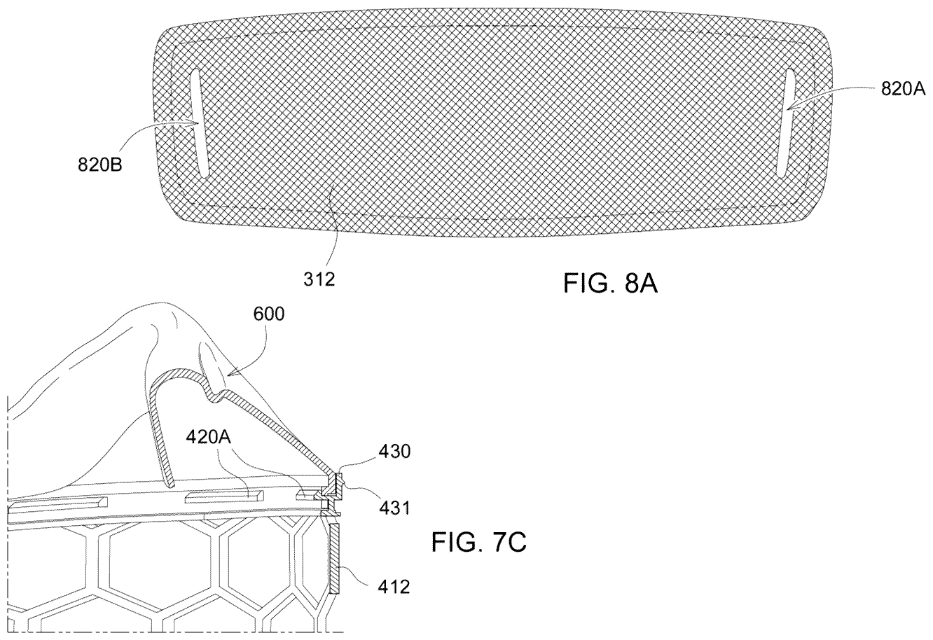

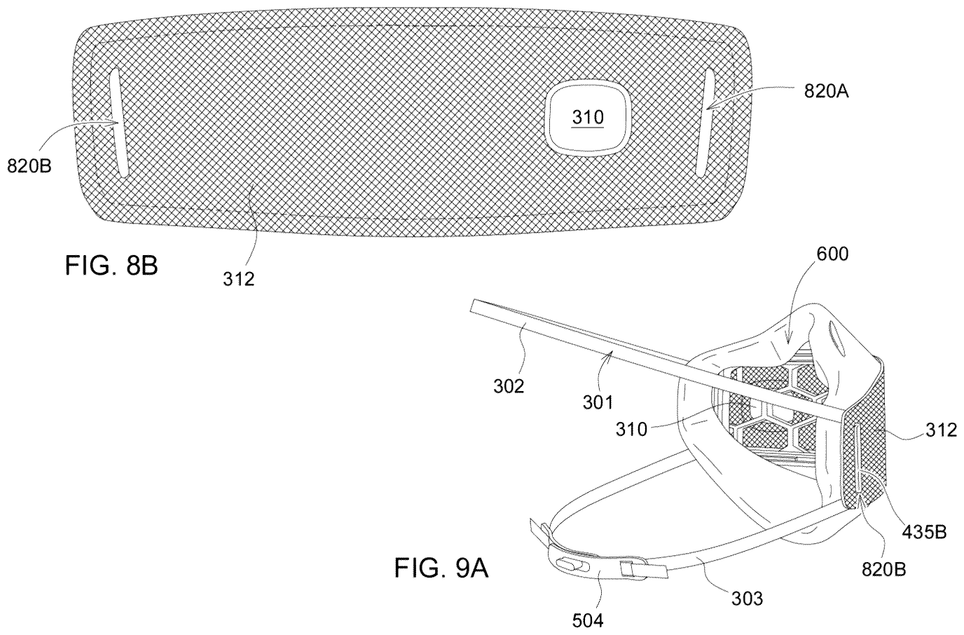

FIG. 8A is the filter material 312. FIG. 8B is the filter material 312 with an exhaust valve 310. The exhaust valve 310 facilitates the removal of exhaled air out of the facial covering assembly 300 to reduce or eliminate the backflow of warm and moist air toward the face of the user. The filter material 312 has a first gap 820A and a second gap 820B. FIG. 9A is a rear perspective view of the filter material 312, the inner frame 401, and the form structure 600. FIG. 9B is a cross-sectional view of the filter material 312, the inner frame 401, and the form structure 600. The inner frame 401 is configured to receive the filter material 312 via the first gap 820A and the second gap 820B. The first protrusion 435A is inserted into the first gap 820A and the second protrusion 435B is inserted into the second gap 820B to couple the filter material 312 to the inner frame 401.

The filter material 312 may include a suitable material which is currently employed for masks such as N95, FFP2 and FFP3. In certain embodiments, the filter material 312 is or includes woven materials, non-woven materials, and/or melt blown materials, such as woven fabrics, non-woven fabric, melt-blown fabrics, woven synthetic and natural fibers, non-woven synthetic and natural fibers, polymers (including co-polymers, tripolymers, and higher-order polymers), paper, cellular plastics, or combinations thereof. In some embodiments, the filter material 312 includes one or more porous materials. The filter material 312 can be in the form of a one-ply, two-ply, or multi-ply fabric, fiber, polymer, etc. In at least one embodiment, the filter material 312 is formed as a laminate of a plurality of layers. In these and other embodiments, one or more layers of the plurality of layers is coated with particles as described herein. The filter material 312 serves as, e.g., a barrier to prevent, mitigate, or reduce passage of virus particles either from a person to the outside environment or from the outside environment to a person.

Illustrative, but non-limiting, examples of materials useful as a filter material 312 include natural fibers/polymers such as cellulosic fibers and proteinacious fibers, e.g., wool, silk, cotton, hemp, and combinations thereof. Illustrative, but non-limiting, examples of materials useful as a filter material 312 also include synthetic fibers/polymers such as polymers (homopolymers or copolymers), such as polyamides including nylon (such as nylon 6 and nylon 66), poly(p-phenylene terephthalamide) (e.g., Kevlar™, Twaron™) and poly (m-phenylenediamine isophthalamide) (e.g., Nomex™); polyolefins such as polypropylene; polyesters such as polyethylene terephthalate (PET); polyureas and block copolymers thereof such as polyurethaneureas; polyurethanes, including polyurethane block copolymers; polyethers, including polyether copolymers such as polyether-polyurea copolymers; acrylics; synthetic cellulose-derived fibers such as rayon; and combinations thereof. In some embodiments, the material or combinations of materials can be woven, non-woven, knitted, felted, thermally bonded, hydroentangled, spunbonded, meltblown, electrospun or formed by other nonwoven processes, or combinations of processes, into, e.g., a fiber, filament, or a fabric.

In some embodiments, non-woven materials include polyethylene, polypropylene, polyester, cotton, and/or combinations thereof, such as polyester poplin silver 62. The non-woven material can also include cellulose and/or viscose. In some embodiments, woven materials include polyester, Spandex™, Nomex™, Montana fleece white 60, cotton, and/or combinations thereof.

In some embodiments, the filter material 312 includes one or more spunbond non-woven materials. A spunbond, also called spunlaid, non-woven material is made in one continuous process. For example, fibers are spun and then directly dispersed into a web by deflectors or can be directed with air streams. In these or other embodiments, the filter material 312 includes one or more spunlace non-woven materials. A spunlace non-woven material is a non-woven cloth, and is the direct use of polymer slices, short fibers and/or filaments into a network of fiber by air, mechanical, spunlace, acupuncture, and/or hot-rolled reinforcement. The decreased cost and ease of manufacture associated with spunbond or spunlace as compared to melt-blown fabric in traditional masks can be beneficial. However, the coated substrates described herein can include melt-blown materials.

Non-woven materials contemplated for implementation according to the embodiments described herein include those manufactured by drylaid, wetlaid, airlaid, and/or spunlaid processes. For these methods of manufacture, a range of bonding processes can be employed to bond the fibers together, including thermobonding, air-through bonding, chemically bonding, needlepunching, stitchbonding, hydroentangling, hydrogenbonding, and/or multibonding.

In some embodiments, The filter material 312 includes mineral oxide particles and iron oxide particles. The filter material 312 having mineral oxide particles and/or iron oxide particles coupled thereto may be considered a coated substrate or at least partially coated substrate. In certain embodiments, the mineral oxide particles are functionalized and/or the iron oxide particles are functionalized.

In some embodiments, the maximum breathing resistance (inhalation or exhalation at 95 L/min according to EN 149:2001) of the filter material 312, with or without mineral oxide and iron oxide particles, is about 10 millibar (mbar) or less, such as about 9 mbar or less, such as about 8 mbar or less, such as about 7 mbar or less, such as about 6 mbar or less, such as about 5 mbar or less, such as about 4 mbar or less, such as about 3 mbar or less, such as about 2 mbar or less, such as about 1 mbar or less.

In at least one embodiment, the maximum breathing resistance (inhalation or exhalation at 160 L/min according to EN 149:2001) of the filter material 312, with or without mineral oxide and iron oxide particles, is about 1.0 mbar or less, such as about 0.5 mbar or less.

In some embodiments, the maximum breathing resistance (inhalation or exhalation at 10 L/min according to EN 149:2001) of the filter material 312, with or without mineral oxide and iron oxide particles, is about 1.5 mbar or less, such as about 1 mbar or less, such as about 0.9 mbar or less, such as about 0.8 mbar or less, such as about 0.7 mbar or less, such as about 0.6 mbar or less, such as about 0.5 mbar or less, such as about 0.4 mbar or less, such as about 0.3 mbar or less, such as about 0.2 mbar or less, such as about 0.1 mbar or less.

In some embodiments, the weight of the filter material 312 is about 150 g/m² or less, such as about 130 g/m² or less, such as from about 10 g/m² to about 130 g/m², such as from about 20 g/m² to about 120 g/m², such as from about 30 g/m² to about 110 g/m², such as from about 40 g/m² to about 100 g/m², such as from about 50 g/m² to about 90 g/m², such as from about 60 g/m² to about 80 g/m². In at least one embodiment, the weight of the filter material 312 is about 15 g/m² to about 100 g/m², such as from about 20 g/m² to about 80 g/m². Weight of the filter material 312 is measured by ASTM D3776.

As discussed above, mineral oxide particles and iron oxide particles are coupled to (e.g., disposed on, dispersed across, impregnated within, embedded within, or otherwise on or in) the filter material 312. The mineral oxide particles, with or without chemical functionalization, have hydrophilic (or superhydrophilic) characteristics that collapse aspirated droplets containing a virus and/or bacteria. The iron oxide particles, with or without chemical functionalization, act to trap the virus. The iron oxide particles, when bound to an organic functional group, can also exhibit hydrophilic (or superhydrophilic) characteristics. In the present disclosure, a superhydrophilic material refers to a material (with or without mineral oxide particles and/or iron oxide particles) having a water droplet absorption time of less than about 1 second.

Suitable iron oxides useful to coat or at least partially coat the filter material 312 can include ferroxanes. The ferroxane can be, or be derived from, e.g., iron (III) oxide, ferric oxide, iron oxide hydroxide, lepidocrocite, goethite, siderogel, limonite, and combinations thereof.

Suitable mineral oxides useful to coat or at least partially coat the filter material 312 can include alumoxanes and/or ferroxanes. The alumoxane can be, or be derived from, e.g., aluminum oxides such as alumina or aluminum oxide hydroxides, such as boehmite and diaspore. The ferroxane can be, or be derived from, e.g., iron (III) oxide, ferric oxide, and iron oxide hydroxides, such as lepidocrocite, goethite, siderogel, limonite, and combinations thereof. Combinations of the mineral oxides described herein may be advantageously implemented. For example, a combination of one or more alumoxanes and one or more ferroxanes may be utilized. In at least one embodiment, the mineral oxide used to create the hydrophilic or superhydrophilic surface is the same mineral oxide used to immobilize the viruses onto the filter material 312. Alternatively, and in some embodiments, the mineral oxide used to create the superhydrophilic surface is different than that used to immobilize the viruses onto the filter material 312.

In certain embodiments, the mineral oxide and/or iron oxide is functionalized with an organic functional group bound (covalently and/or physically) to the surface of the mineral oxide and/or iron oxide. An illustrative, but non-limiting, example of an organic functional group that can be used includes a carboxylic acid group, RCO₂H, or its deprotonated form as a carboxylate group, RCO₂—. R can be saturated or unsaturated, substituted or unsubstituted, linear or branched, cyclic or acyclic, aromatic or non-aromatic. In some embodiments, R is a C₁-C₁₀₀ unsubstituted hydrocarbyl (such as C₁-C₄₀ unsubstituted hydrocarbyl, such as C₁-C₂₀ unsubstituted hydrocarbyl, such as C₁-C₁₀ unsubstituted hydrocarbyl, such as C₁-C₆ unsubstituted hydrocarbyl), a C₁-C₁₀₀ substituted hydrocarbyl (such as C₁-C₄₀ substituted hydrocarbyl, such as C₁-C₂₀ substituted hydrocarbyl, such as C₁-C₁₀ substituted hydrocarbyl, such as C₁-C₆ substituted hydrocarbyl), a C₄-C₁₀₀ unsubstituted aryl (such as C₄-C₄₀ unsubstituted aryl, such as C₄-C₂₀ unsubstituted aryl, such as C₄-C₁₀ unsubstituted aryl), or a C₄-C₁₀₀ substituted aryl (such as C₄-C₄₀ substituted aryl, such as C₄-C₂₀ substituted aryl, such as C₄-C₁₀). In at least one embodiment, the hydrocarbyl is linear or branched.

In at least one embodiment, and when R is a substituted hydrocarbyl or a substituted aryl, at least one carbon of the substituted hydrocarbyl or the substituted aryl has been substituted with at least one heteroatom or heteroatom-containing group, such as one or more elements from Group 13-17 of the periodic table of the elements, such as halogen (F, Cl, Br, or I), O, N, Se, Te, P, As, Sb, S, B, Si, Ge, Sn, Pb, and the like, such as NR*₂, OR* (e.g., OH or O₂H), SeR*, TeR*, PR*₂, AsR*₂, SbR*₂, SR*, SOₓ (where x=2 or 3), BR*₂, SiR*₃, GeR*₃, SnR*₃, PbR*₃, and the like or where at least one heteroatom has been inserted within the hydrocarbyl radical or aryl radical such as one or more of halogen (CI, Br, I, F), O, N, S, Se, Te, NR*, PR*, AsR*, SbR*, BR*, SiR*₂, GeR*₂, SnR*₂, PbR*₂, and the like, where R* is, independently, hydrogen, or hydrocarbyl (e.g., C₁-C₁₀), or two or more R* may join together to form a substituted or unsubstituted completely saturated, partially unsaturated, fully unsaturated, or aromatic cyclic or polycyclic ring structure.

The choice of the group R can affect the hydrophilic functionality. Suitable carboxylic acids/carboxylates useful include those described in U.S. Pat. Nos. 7,115,764 and 6,770,773 each of which is incorporated herein by reference in its entirety. Illustrative, but non-limiting, examples of carboxylic acids/carboxylates used to functionalize mineral oxides and/or functionalize iron oxides include cysteic acid, 3,5-dihydroxybenzoic acid, para-hydroxybenzoic acid, malonic acid, carboxylates thereof, derivatives thereof, and combinations thereof.

The mineral oxides, with or without functionalization, and/or the iron oxides, with or without functionalization, are added to the filter material 312 in the form of, e.g., particles, such as nanoparticles. The mineral oxide particles and the iron oxide particles have a diameter of between about 10 nm and about 200 nm. More specifically, a median diameter of the mineral oxide particles and the iron oxide particles is between about 10 nm and about 200 nm. Upon addition of the particles to the filter material 312 and drying/curing, the filter material 312 becomes a coated (or at least partially coated) substrate. “Coated” can be in the form of particles coupled to, disposed on or in, dispersed across, impregnated within, embedded within, or otherwise disposed on or in, the filter material 312. In one embodiment, the particles are in a particulate form prior to performing a curing process but fuse together after performing the curing process.

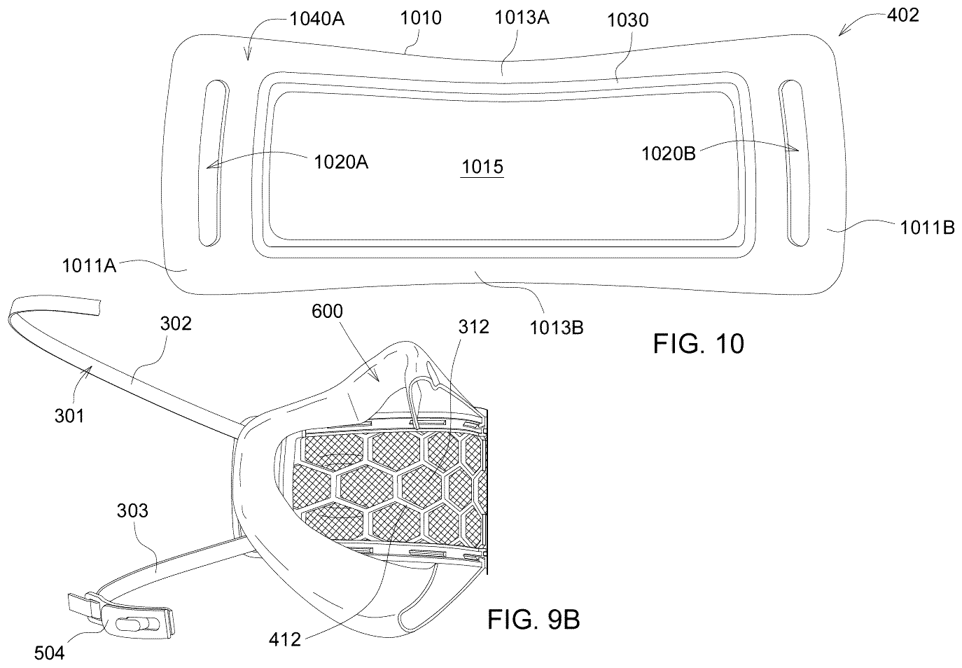

The facial covering assembly 300 is a simpler structure with regard to the shape of the filter material 312 when compared to that for current surgical and other PPE masks, resulting in lower manufacturing cost. FIG. 10 is a rear view of the outer frame 402. The outer frame 402 includes an outer frame body 1010 and an outer frame opening 1015 formed in the outer frame body 1010. The outer frame body 1010 has an inner surface 1040A and an outer surface 1040B. The outer frame body 1010 further includes a first end portion 1011A, a second end portion 1011B, an upper connector 1013A, and a lower connector 1013B. The outer frame opening 1015 is defined by the first end portion 1011A, the second end portion 1011B, the upper connector 1013A, and the lower connector 1013B. The first end portion 1011A and the second end portion 1011B are connected via the upper connector 1013A and the lower connector 1013B. The outer frame 402 further includes a first protrusion opening 1020A, a second protrusion opening 1020B, and an inner ridge 1030. The inner ridge 1030 surrounds the outer frame opening 1015. The outer frame 402 is made of a polymer, for example, an ABS plastic, polymethyl methacrylate (PMMA), polyethylene terephthalate glycol (PETG), or polylactic acid (PLA) or other suitable material.

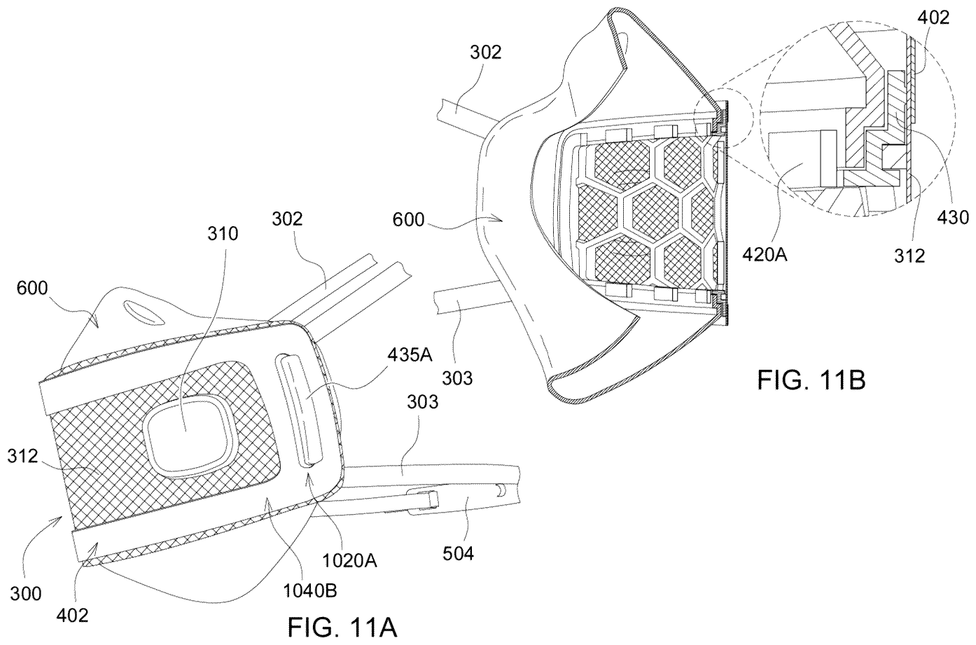

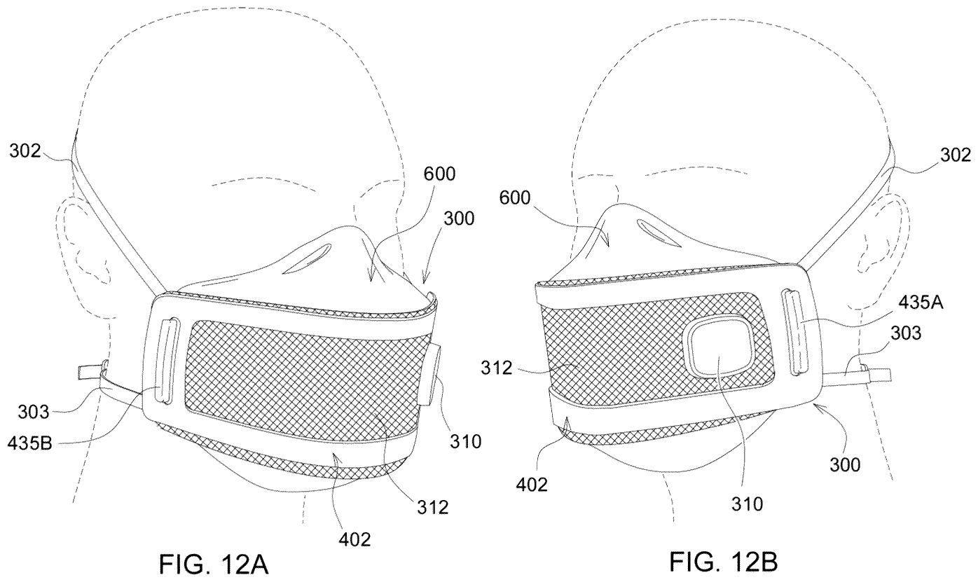

FIG. 11A is a front perspective view of the facial covering assembly 300. FIG. 11B is a cross-sectional view of the facial covering assembly 300. FIG. 12A is a first front perspective of the facial covering assembly 300 secured to a user. FIG. 12B is a second front perspective of the facial covering assembly 300 secured to a user. The inner ridge 1030 of the outer frame 402 is configured to interdigitate with the filter ridge 430 of the inner frame 401. The filter ridge 430 on the outer surface 440B of the inner frame 401 and the inner ridge 1030 of the outer frame 402 interdigitate to create a seal with the filter material 312. The filter clamp 431 further enhances the seal between the filter material 312, the inner frame 401, and the outer frame 402. The first protrusion opening 1020A is configured to receive the first protrusion 435A and the second protrusion opening 1020B is configured to receive the second protrusion 435B. The coupling of the first protrusion opening 1020A and the first protrusion 435A creates a seal with the filter material 312 between the first end portion 411A of the inner frame 401 and the first end portion 1011A of the outer frame 402. The coupling of the second protrusion opening 1020B and the second protrusion 435B creates a seal with the filter material 312 between the second end portion 411B of the inner frame 401 and the second end portion 1011B of the outer frame 402.

Informal testing of various embodiments of the mask and eye shield(s) disclosed herein by the inventors hereof in situ (i.e., during one or more closed surgical procedures) indicate markedly improved performance of the disclosed mask and/or eye shielding equipment over the current state of the art, especially in terms of the above-described aspects of reduced “fogging” of optical equipment, comfort, and reduced/eliminated trauma upon removal, including over extended surgical procedures lasting many hours.

### Embodiments Listing

Clause 1. A facial covering assembly including: a) a form structure supporting a fitment around the mouth and nose of varied facial types during normal facial expression and movement of the user; b) a substantially convex inner frame with an opening supporting a skeletal structure allowing ready air flow; c) a filter material shaped to fit, and be located, over the opening of the inner frame and supported by the skeletal structure of the inner frame; d) an outer frame shaped to compliment the curve of the inner frame with an opening to facilitate air flow, and creates a seal with the filter material; and e) one or more bands, strings, elasticated loops or straps attached to the inner frame that tie or fasten at the back of the users head, wherein the inner frame and outer frame creates a seal with the filter material, and the convex shape of the inner frame and outer frame ensures the filter material is held away from the users nose and mouth.
Clause 2. The facial covering assembly of at least clause 1, wherein the form structure and the inner frame have complementary tabs, slots, ridges, or catches that create a seal between the form structure and the inner frame while retaining the flexibility of the facial covering assembly to the users face.
Clause 3. The facial covering assembly of at least clause 1, wherein the inner frame and the filter material have complementary tabs and slots that ensure the location of the filter material over the inner frame.
Clause 4. The facial covering assembly of at least clause 1, wherein the inner frame and the outer frame have complementary ridges that create a seal between the inner frame, the filter material, and the outer frame.
Clause 5. The facial covering assembly of at least clause 1, wherein the inner frame has complementary tabs, slots, or catches that allow attachment of one or more bands, strings, elasticated loops or straps attached to the inner frame that tie or fasten at the back of the users head.
Clause 6. The facial covering assembly of at least clause 1, wherein the form structure is made from a polymer chosen from a silicone, Thermoplastic, Neoprene or a Synthetic rubber.
Clause 7. The facial covering assembly of at least clause 1, wherein the inner frame is made from a polymer chosen from an acrylonitrile butadiene styrene (ABS), polymethyl methacrylate (PMMA), polyethylene terephthalate glycol (PETG), or polylactic acid (PLA).
Clause 8. The facial covering assembly of at least clause 1, wherein the outer frame is made from a polymer chosen from acrylonitrile butadiene styrene (ABS), polymethyl methacrylate (PMMA), polyethylene terephthalate glycol (PETG), or polylactic acid (PLA).
Clause 9. The facial covering assembly of at least clause 1, wherein the filter material has multiple layers of suitable polymer and fabric materials.
Clause 10. The facial covering assembly of at least clause 9, wherein the filter material comprises of melt-blown polypropylene and spun-lace polypropylene.
Clause 11. The facial covering assembly of at least clause 10, wherein the filter material meets FFP2, FFP3 or N95 standards.
Clause 12. The facial covering assembly of at least clause 10, wherein the filter material includes a layer impregnated with a viral trapping material such as cysteic acid mineral oxide.
Clause 13. A facial covering assembly including: a) a form structure that is shaped to allow fitment around the mouth and nose of varied facial types during normal facial expression and movement of the user; b) a first, substantially convex, inner frame with an opening supporting a skeletal structure allowing ready air flow; c) a filter material shaped to fit, and be located, over the opening of the inner frame and supported by the skeletal structure of the inner frame; d) an outer frame, containing an exhaust valve, shaped to compliment the curve of the inner frame and creates a seal with the filter material; and e) one or more bands, strings, elasticated loops or straps attached to the inner frame that tie or fasten at the back of the users head, wherein the inner frame and outer frame creates a seal with the filter material, and the convex shape of the inner frame and the outer frame ensures the filter material is held away from the users nose and mouth.
Clause 14. The facial covering assembly of at least clause 13, wherein the form structure and the inner frame have complementary tabs, slots, ridges, or catches that create a seal between the form structure and the inner frame while retaining the flexibility of the facial covering assembly to the users face.
Clause 15. The facial covering assembly of at least clause 13, wherein the inner frame and the filter material have complementary tabs and slots that ensure the location of the filter material over the inner frame.
Clause 16. The facial covering assembly of at least clause 13, wherein the inner frame and the outer frame have complementary ridges that create a seal between the inner frame, the filter material and the outer frame.
Clause 17. The facial covering assembly of at least clause 13, wherein the inner frame has complementary tabs, slots, or catches that allow attachment of one or more bands, strings, elasticated loops or straps attached to the inner frame that tie or fasten at the back of the users head.
Clause 18. The facial covering assembly of at least clause 13, wherein the form structure is made from a polymer chosen from a silicone, thermoplastic, neoprene or a synthetic rubber.
Clause 19. The facial covering assembly of at least clause 13, wherein the inner frame is made from a polymer chosen from an acrylonitrile butadiene styrene (ABS), polymethyl methacrylate (PMMA), polyethylene terephthalate glycol (PETG), or polylactic acid (PLA).
Clause 20. The facial covering assembly of at least clause 13, wherein the outer frame is made from a polymer chosen from an acrylonitrile butadiene styrene (ABS), polymethyl methacrylate (PMMA), polyethylene terephthalate glycol (PETG), or polylactic acid (PLA).
Clause 21. The facial covering assembly of at least clause 13, wherein the filter material has multiple layers of suitable polymer and fabric materials.
Clause 22. The facial covering assembly of at least clause 21, wherein the filter material may include of melt-blown polypropylene and spun-lace polypropylene.
Clause 23. The facial covering assembly of at least clause 22, wherein the filter material meets FFP2, FFP3 or N95 standards.
Clause 24. The facial covering assembly of at least clause 21, wherein the filter material includes a layer impregnated with a viral trapping material such as cysteic acid mineral oxide.

It may be recognized that while the foregoing discussion of the various aspects of the disclosure has described specific sequences of steps necessary to perform the methods of the present disclosure, other sequences of steps may be used depending on the particular application. Specifically, additional steps may be added, and other steps deleted as being optional. Furthermore, the order of performance of certain steps may be permuted, and/or performed in parallel with other steps. Hence, the specific methods disclosed herein are merely exemplary of the broader methods of the disclosure.

It may be further appreciated that while certain steps and aspects of the various methods and apparatus described herein may be performed by a human being, the disclosed aspects and individual methods and apparatus are generally computerized/computer-implemented. Computerized apparatus and methods are necessary to fully implement these aspects for any number of reasons including, without limitation, commercial viability, practicality, and even feasibility (i.e., certain steps/processes simply cannot be performed by a human being in any viable fashion).

While the above detailed description has shown, described, and pointed out novel features of the disclosure as applied to various embodiments, it may be understood that various omissions, substitutions, and changes in the form and details of the device or process illustrated may be made by those skilled in the art without departing from the disclosure. The described embodiments are to be considered in all respects only illustrative and not restrictive. The scope of the disclosure is, therefore, indicated by the appended claims rather than the foregoing description. All changes that come within the meaning and range of equivalence of the claims are embraced within their scope.

While various embodiments have been described above, it may be understood by a person of ordinary skill in the art that the description has been presented by way of example only, and not limitation. Thus, the breadth and scope of the claims or a preferred embodiment may not be limited by any of the above-described exemplary embodiments but may be defined only in accordance with the following claims and their equivalents.

What is claimed is:

1. A facial covering assembly, comprising:
a form structure comprising a form structure opening;
an inner frame coupled to the form structure, the inner frame comprising:
an inner frame body; and
an inner frame opening disposed in the inner frame body;
an outer frame coupled to the inner frame, comprising:
an outer frame body; and
an outer frame opening disposed in the outer frame body;
a filter material coupled to the inner frame and disposed between the inner frame and the outer frame; and
a fastener coupled to the inner frame.

2. The facial covering assembly of claim 1, wherein the form structure comprises:
an upper exterior surface;
a first ridge extending from the upper exterior surface and into the form structure opening;
a lower exterior surface; and
a second ridge extending from the lower exterior surface and into the form structure opening.

3. The facial covering assembly of claim 2, further comprising first slots disposed in the first ridge and second slots disposed in the second ridge.

4. The facial covering assembly of claim 3, wherein the inner frame further comprises:
one or more upper tabs received within the first slots of the form structure; and
one or more lower tabs received within the second slots of the form structure.

5. The facial covering assembly of claim 2, further comprising indentations located in the upper exterior surface.

6. The facial covering assembly of claim 1, wherein the form structure is made from a polymer chosen from a silicone, thermoplastic, neoprene or a synthetic rubber.

7. The facial covering assembly of claim 1, wherein the inner frame and the outer frame include an acrylonitrile butadiene styrene (ABS), polymethyl methacrylate (PMMA), polyethylene terephthalate glycol (PETG), or polylactic acid (PLA).

8. A facial covering assembly, comprising:
a form structure comprising a form structure opening;
an inner frame coupled to the form structure, the inner frame comprising:
an inner frame body;
an opening disposed in the inner frame body; and
an inner frame structure is disposed within the opening;
an outer frame coupled to the inner frame, comprising:
an outer frame body; and
an opening disposed in the outer frame body;
a filter material coupled to the inner frame and disposed between the inner frame and the outer frame, wherein the inner frame structure supports the filter material; and
a fastener coupled to the inner frame.

9. The facial covering assembly of claim 8, wherein the inner frame a hexagonal matrix.

10. The facial covering assembly of claim 8, wherein the inner frame body comprises:
a first protrusion disposed on an outer surface of the inner frame body on a first end portion; and
a second protrusion disposed on the outer surface of the inner frame body on a second end portion; and
wherein the outer frame comprises:
a first protrusion opening, wherein the first protrusion is received within the first protrusion opening; and
a second protrusion opening, wherein the second protrusion is received within the second protrusion opening.

11. The facial covering assembly of claim 8, wherein the inner frame body further comprises a filter ridge formed on an outer surface of the inner frame body and surrounding the inner frame opening; and
wherein the outer frame body comprises an inner ridge formed on an inner surface of the outer frame body and surrounding the outer frame opening, and wherein the filter ridge and the inner ridge interdigitate.

12. The facial covering assembly of claim 8, wherein the filter material comprises an exhaust valve.

13. The facial covering assembly of claim 8, wherein the form structure comprises silicone, thermoplastic, neoprene, or a synthetic rubber.

14. The facial covering assembly of claim 8, wherein the filter material comprises a layer impregnated with a viral trapping material.

15. A facial covering assembly, comprising:
a form structure comprising a form structure opening;
an inner frame coupled to the form structure, the inner frame comprising:
an inner frame body, comprising:
a first end portion;
a second end portion;
an upper connector; and
a lower connector, wherein the first end portion and the second end portion are connected via the upper connector and the lower connector;
an inner frame opening disposed in the inner frame body and defined by the first end portion, the second end portion, the upper connector, and the lower connector;
an inner frame structure is disposed within the opening;
a first protrusion disposed on an outer surface of the inner frame body on the first end portion; and
a second protrusion disposed on an outer surface of the inner frame body on the second end portion;
an outer frame coupled to the inner frame, comprising:
an outer frame body comprising:
a first end portion;
a second end portion;
an upper connector; and
a lower connector, wherein the first end portion and the second end portion are connected via the upper connector and the lower connector;
an outer frame opening disposed in the outer frame body and defined by the first end portion, the second end portion, the upper connector, and the lower connector;
a first protrusion opening, wherein the first protrusion is received within the first protrusion opening; and
a protrusion opening, wherein the second protrusion is received within the second protrusion opening;
a filter material coupled to the inner frame and disposed between the inner frame and the outer frame, wherein the inner frame structure supports the filter material; and
a fastener coupled to the inner frame.

16. The facial covering assembly of claim 15, wherein the inner frame body further comprises a filter ridge formed on the outer surface of the inner frame body and surrounding the inner frame opening; and
wherein the outer frame body comprises an inner ridge formed on an inner surface of the outer frame body and surrounding the outer frame opening, and wherein the filter ridge and the inner ridge interdigitate.

17. The facial covering assembly of claim 15, wherein the filter material comprises a first gap and a second gap, wherein the first protrusion is received within the first gap and the second protrusion is received within the second gap.

18. The facial covering assembly of claim 15, wherein the fastener comprises bands, strings, elasticated loops or straps configured to tie or fasten at a back of a user's head.

19. The facial covering assembly of claim 15, wherein the fastener comprises a fastener clasp configured to adjust the fastening of the facial covering assembly to a user's head.

20. The facial covering assembly of claim 15, wherein the filter material comprises a layer impregnated with a viral trapping material.
